(19) United States
(12) Patent Application Publication
(10) Pub. No.: US 2004/0011822 A1
(43) Pub. Date: Jan. 22, 2004

(54) Delivery device

(76) Inventors: Douglas Jennings, Hertfordshire (DE); Bruce Macmichael, Hertfordshire (DE); Michael Paton, Hertfordshire (DE)

Correspondence Address: FISH & RICHARDSON PC, 225 FRANKLIN ST, BOSTON, MA, 02110, US

(21) Appl. No.: 10/381,765

(22) PCT Filed: Oct. 9, 2001
(86) PCT No.: PCT/SE01/02202

(30) Foreign Application Priority Data
Oct. 11, 2000 (SE) 0003665-7

(51) Int. Cl. G01F 11/06

(52) U.S. Cl. 222/321.8

(57) ABSTRACT

The present invention relates to a manually actuated delivery device for the delivery of a volume of liquid comprising a housing (1) which includes an outlet (3) through which liquid, in use, is delivered, a liquid delivery unit (24) which is located within the housing (1) and an actuating means (2) which is moveable from a first position to a second position when acted upon by a user. The liquid delivery unit (24) is held by a locking mechanism (28) in a non-actuatable mode and the actuating means (2) cooperates with an interfering member (26) as it moves from the first position to the second position such that the interfering member (26) eventually releases the liquid delivery unit (24) from the locking mechanism (28) to enable delivery of the liquid.

The present invention relates to a manually actuated delivery device for the delivery of a volume of liquid, in particular, a liquid containing medicament.

WO-92/20455 discloses one example of such a delivery device which takes the form of a nasal inhaler for the delivery of a volume of liquid containing medicament as a spray into a nasal cavity. This delivery device includes a nosepiece in the form of an elongate tubular section for insertion into a nasal cavity. The distal end nosepiece delivers the spray and is configured to be manually actuated by the application of a force axially relative to the longitudinal axis of the nosepiece.

Whilst such a delivery device is capable of delivering a volume of liquid, in practice, use as a nasal spray can prove troublesome since the actual volume of liquid delivered and the energy of delivery can be dependent on the force applied by the user. Moreover, the axial application of force tends to cause axial movement of the nosepiece within the nasal cavity which can lead to inefficient delivery of liquid.

The present invention, therefore, aims to overcome the aforementioned problems by ensuring that the volume and energy of liquid delivered is consistent and by providing a delivery device which is configured such that the force applied by the user is substantially orthogonal to the axis of delivery of liquid. With such a configuration, inadvertent withdrawal or movement of the nosepiece can be avoided.

The main advantage of the present invention is the locking of the liquid delivery unit into a non-actuatable mode after each delivery of liquid, to avoid unintentional actuation unless force is applied by the user in the required manner.

An additional advantage of the present invention arises by virtue of the use of a biasing means to actuate the delivery of liquid which results in a consistent energy of delivery regardless of the force applied by the user.

According to the present invention, there is provided a manually actuatable delivery device for the delivery of a volume of liquid comprising:

a housing which includes an outlet through which liquid, in use, is delivered;

a liquid delivery unit which is located within the housing; and

an actuating means moveable from a first position to a second position when acted upon by a user characterised in that

the liquid delivery unit is held by a locking mechanism in a non-actuatable mode and the

actuating means cooperates with an interfering member as it moves from the first position to

the second position such that the interfering member eventually releases the liquid delivery

unit from the locking mechanism to enable delivery of the liquid.

Preferably, the interfering member is moveable against the biasing action of a biasing means.

Preferably, the actuating means lifts the interfering member into contact with the locking mechanism.

Preferably, the actuating means cooperates with the interfering member by way of a coupling member.

Preferably, the coupling member lifts the interfering member into contact with the locking mechanism.

Preferably, the interfering member is a tubular member which is slidable with respect to the liquid delivery unit.

Preferably, the locking mechanism is an expandable collar.

Preferably, the tubular member moves into contact with the expandable collar as the actuating means is moved into the second position, such that the collar widens in diameter to allow the liquid delivery unit to pass through it and deliver a volume of liquid.

Preferably, the delivery device further comprises a carrier unit for the liquid delivery unit, the carrier unit and liquid delivery unit being slidable as a single unit within the housing.

Preferably, the tubular member slides on the carrier unit.

Preferably, the biasing means is a spring located between the carrier unit and the tubular member which is compressed as the tubular member is lifted by the coupling member.

Preferably, the liquid delivery unit comprises a container for the liquid and a pump with a tubular nozzle, the tubular nozzle being slidable into the container to deliver a volume of liquid as a result of cooperation with a tubular feed within the housing which leads to the outlet.

Preferably, the user actuates the actuating means by applying a force substantially orthogonal to the axis of delivery of the liquid.

Preferably, the actuating means comprises a cover member which is moveably disposed relative to the housing between a first position in which the cover member at least partly covers the outlet and a second position in which the cover member acts as a lever to which the user applies force to actuate the delivery device.

A preferred embodiment of the present invention will now be described in detail by way of example only, with reference to the accompanying drawings, of which:

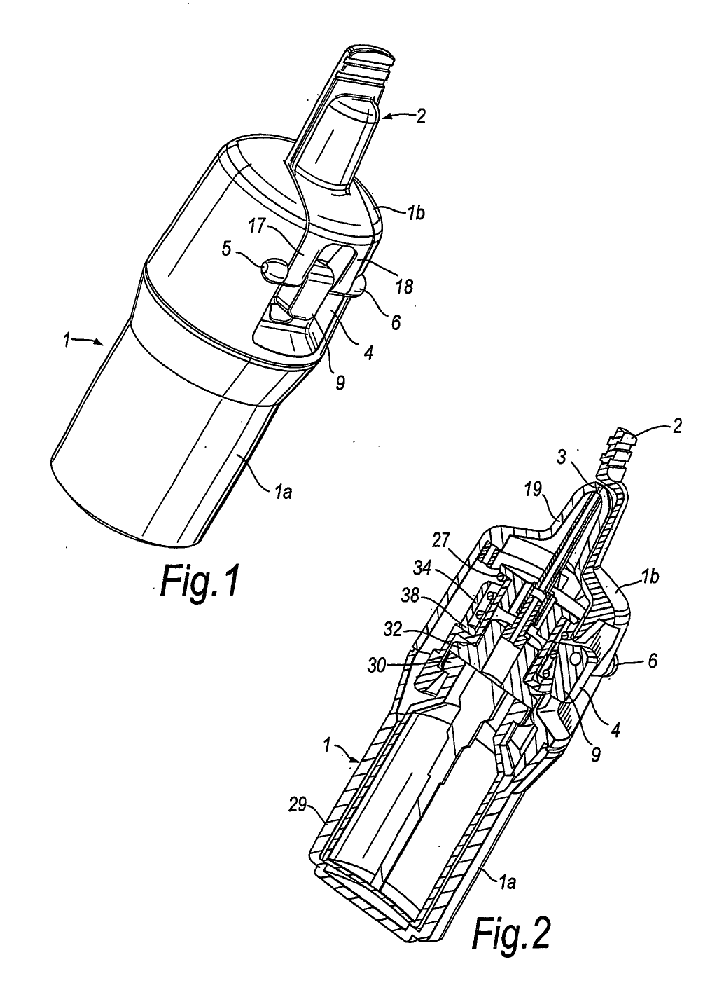

FIG. 1 is a perspective view of the delivery device;

FIG. 2 is a perspective sectional view of the delivery device in FIG. 1;

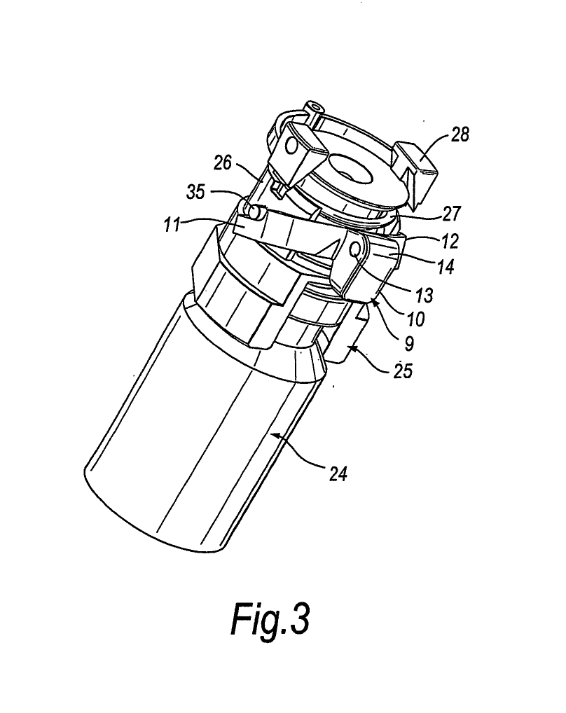

FIG. 3 is a perspective view of some of the internal features of the delivery device depicted in FIGS. 1 and 2;

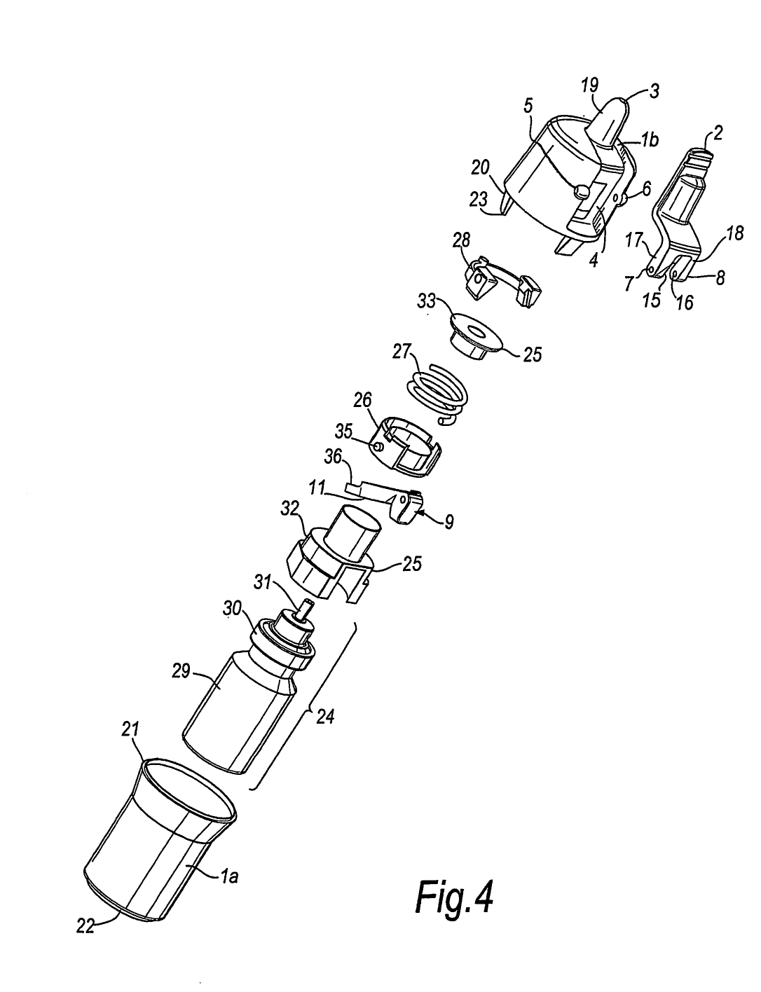

FIG. 4 is an exploded view in perspective of all the features of the delivery device depicted in FIGS. 1 and 2;

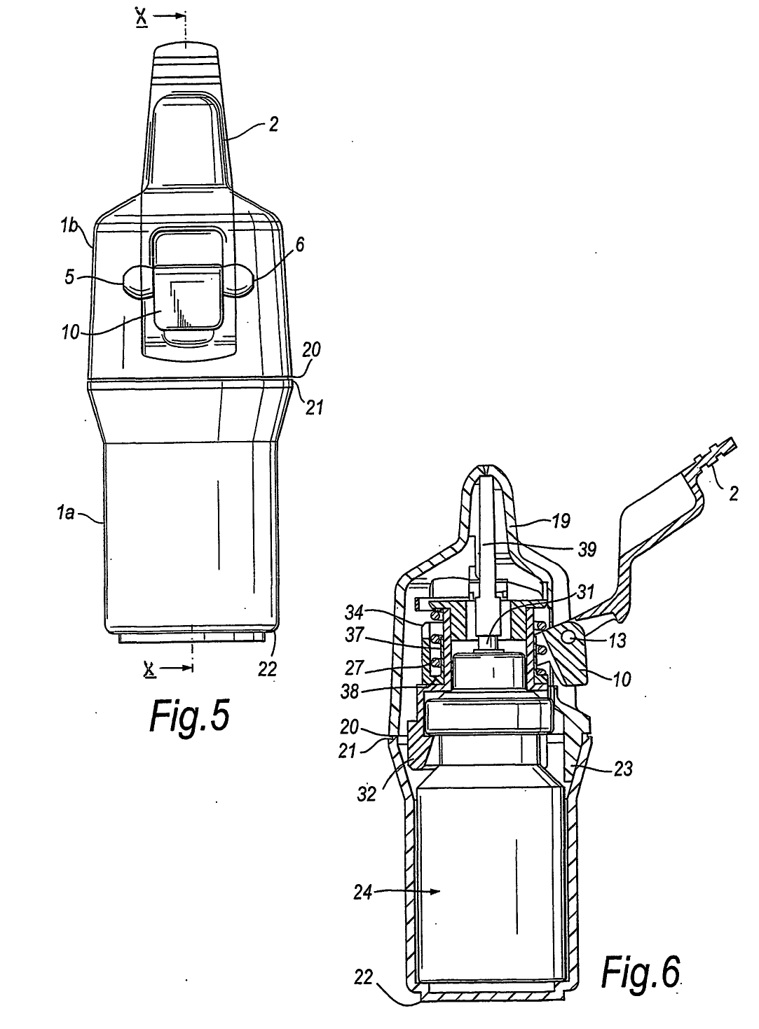

FIG. 5 is a view from the right hand side of the delivery device in FIG. 1;

FIG. 6 is a sectional view in direction X-X of the delivery device in FIG. 5 with the cover member in the second position;

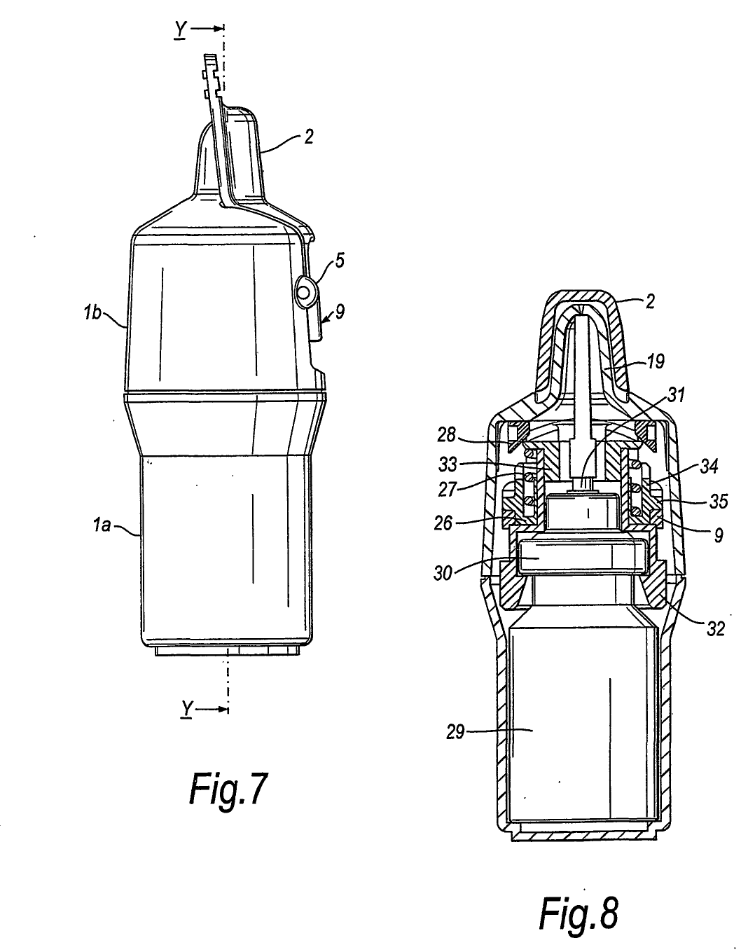

FIG. 7 is a view from the front of the delivery device in FIG. 1;

FIG. 8 is a sectional view in direction Y-Y of the delivery device in FIG. 7;

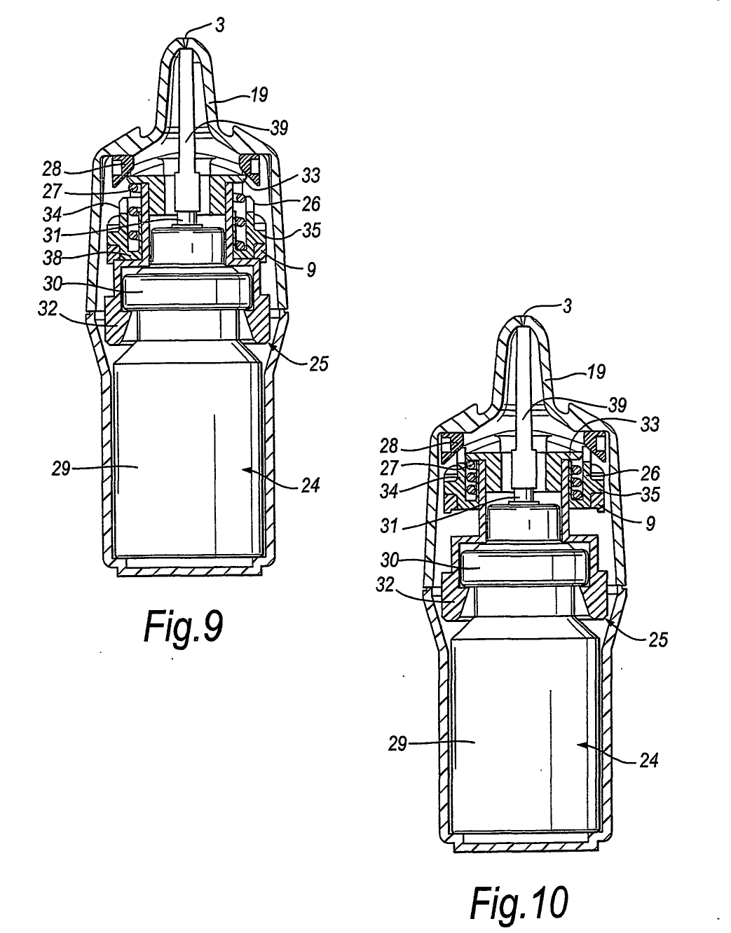

FIG. 9 corresponds to FIG. 8 and depicts the delivery device in a non-actuatable mode with the cover member in the second position; and

FIGS. 10, 11 and 12 correspond to FIG. 9 with the cover member in the second position, having cooperated with the internal liquid delivery assembly, at various stages of actuation of the liquid delivery.

The delivery device comprises a housing 1 and a cover member 2. In FIG. 1, the cover member 2 is in a first position covering the outlet 3 through which liquid is delivered. The housing 1 comprises a lower body 1 a and an upper body 1b typically formed of a plastics material and joined by a plastics weld after insertion of the internal liquid delivery assembly.

The upper body 1b includes a lateral opening 4 which in this embodiment is of substantially rectangular shape. The upper body 1b has first and second sockets 5, 6 in the form of bearing surfaces which are located on opposite sides of the lateral opening 4. Each socket 5,6 cooperates with a corresponding projection 7,8 on each side of the cover member 2 (FIG. 4). In this way, the cover member 2 is pivotally hinged on the upper body 1b enabling rotational movement from the first position where the outlet 3 is covered (FIG. 2) to the second position where the outlet 3 is exposed and the cover member 2 actuates the internal liquid delivery assembly (FIG. 6).

The cover member 2 is also rotatable with respect to a coupling member 9 in the form of a yoke with a body 10 and arms 11 and 12. The body 10 is provided with sockets 13, 14 which cooperate with corresponding projections 15,16 on the cover member 2. The cover member 2 is configured to sit in the lateral opening 4 with the body 10 of the coupling member 9 between its legs 17 and 18. The legs 17 and 18 include the projections 7, 15 and 8, 16 respectively.

The upper body 1b is configured with a nosepiece 19 which tapers towards the outlet 3. The upper body 1b is of generally tubular cross-section below the nosepiece 19 has an open end 20 where it connects with the lower body 1a. The lower body 1a is also of generally tubular cross-section having an open end 21 and a closed base 22. The open end 21 of the upper body 1b includes resilient tabs 23 which are a sliding fit in the open end 22 of the lower body 1a to secure the upper and lower body parts together to form the housing 1. The upper and lower body parts may also be secured further by means of a plastic seal achieved, for example, by ultrasonic welding.

The delivery device comprises a liquid delivery assembly generally depicted in FIG. 3. In FIG. 3 the housing 1 and cover member 2 are not shown leaving only the internal elements of the device. The liquid delivery assembly includes a liquid delivery unit 24, a carrier unit 25, the coupling member 9, an interfering member 26, a biasing means 27 and a locking mechanism 28 which sits in the upper part 1b of the housing 1.

The liquid delivery unit 24 comprises a container 29 and a pump 30 having a tubular nozzle 31. The tubular nozzle 31 is slidable into the container 29 against the action of an internal return spring (not shown). The carrier unit 25 comprises a main body 32 and cap 33. The upper part of the liquid delivery unit 24, i.e. pump 30 is locked inside the main body 32 of the carrier unit 25. The interfering member 26 is in the form of a tubular member slidable on the main body 32 of the carrier unit 25. On each side of the outer wall 34 of the tubular member 26 is a projection 35, each of which cooperates with an arm 11,12 of the coupling member 9. The arms 11 and 12 have a recess 36 in which a respective projection 35 sits. The tubular member 26 is constructed with an outer wall 34 and an inner wall 37 connected by a base wall 38.

A biasing member 27 is in the form of a spring and sits between the inner and outer walls of the tubular member 26. The cap 33 of the carrier unit 25 sits on and is secured to the main body 32 and forms a surface against which the spring 27 bears during actuation of the delivery device.

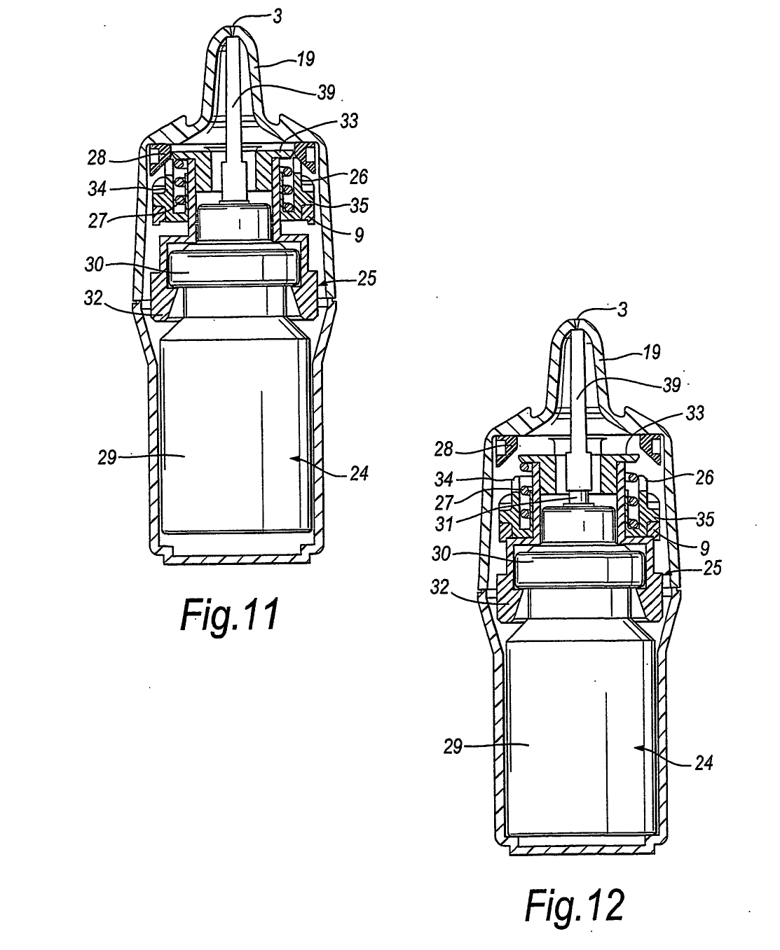

A locking mechanism 28 in the form of an expandable collar member is located in the upper body 1b of the housing 1 which is contacted by the outer wall 34 of the tubular member 26 when the coupling member 9 lifts the tubular member 26 to a predetermined position against the action of the spring 27 (FIGS. 10 and 11). In this position, the outer wall 34 forces the collar member 28 to expand radially outwards so that eventually the carrier unit 25 can pass through the collar member 28 (FIG. 12).

When not in use, the cover member 2 sits in the closed position (FIGS. 1 and 5) and acts as a cover for the outlet 3. In this position, there is no engagement with the coupling member 9 and, therefore, it is not possible to actuate the delivery device.

In use, a user takes the delivery device in one hand and lifts the cover member 2 rotating the same from the closed position (FIGS. 1 and 5) to the open position (FIG. 6). The nosepiece 19 is then fully exposed and the outlet 3 is unobstructed to allow delivery of liquid to a nasal cavity. In the open position the cover member 2 cooperates with the coupling member 9 making the body 10 pivot on the hinge axis which is formed by the projections and respective sockets on the upper body 1b, the legs 17,18 of the cover member 2 and the body 10. The user then inserts the nosepiece 19 into a nasal cavity and actuates the delivery device by applying force to the cover member 2 which acts as a lever, lifting the arms 11 and 12 of the coupling member 2. Since the user is applying a force to the cover member 2 which results in an actuation force which is substantially orthogonal to the axis of delivery, there is unlikely to be inadvertent withdrawal or movement of the nosepiece during use. The upward movement of the arms 11 and 12 forces the tubular member 26 to move upwards, against the biasing action of spring 27, as a result of engagement between the recesses 36 and projections 35.

Reference should now be made to FIGS. 9 to 12 which depict the various positions of the liquid delivery assembly during actuation.

In FIG. 9, the cover member 2 is in the open position and the spring 27 biases the tubular member 26 downwards. In this Figure, the cover member 2 is in the open position but no force has been applied to make the coupling member 9 lift the tubular member 26. The spring 27 is, therefore, extended between the base wall 38 of the tubular member 26 and the cap 33 of the carrier unit 25. In FIG. 10, force has been applied and the tubular member 26 commences its stroke, rising against the biasing action of the spring 27. The carrier unit 25 and liquid delivery unit 24 remain in position with the cap 33 pressed against the collar member 28. The outer wall 34 of the tubular member 26 eventually makes contact with the collar member 28. In this position, the correspondingly slanted surfaces of the outer wall 34 and collar member 28 slide with respect to each other as the upward stroke of the tubular member 26 progresses. Eventually, the collar member 28 expands radially and has a large enough internal diameter to allow the cap 33 of the carrier unit 25 to pass through it. FIG. 11 depicts how the spring 27 is then allowed to extend pushing the cap 33 upwards together with the main body 32. Since the liquid delivery unit 24 is held by the carrier unit 25, the entire liquid delivery unit 24 moves upwards and the tubular nozzle 31 cooperates with a tubular feed 39 which pushes the nozzle 31 into the container 29 to actuate liquid delivery by 10 way of the pump 30. The tubular feed 39 leads to the outlet 3 from the housing. After actuation the user releases the cover member 2 which in turn allows the coupling member 9 to return to its original position. The spring 27 will then extend (FIG. 12) urging the tubular member to commence the downward stroke. The carrier unit 25 and liquid delivery unit 24 will then be pushed back into the non-actuatable position until force is once again applied to the cover member 2. After actuation, the cap 33 drops sufficiently to allow the collar member 28 to assume its original diameter moving radially inwards to sit above the cap as in FIG. 9. In this way, the delivery device is able to deliver a substantially constant volume of liquid with a consistent energy of delivery regardless of the force applied by the user to the actuating means. Although it is preferable that the user applies the force substantially orthogonally to the axis of the delivered liquid, it will be understood that alternative actuating means could be employed with the locking mechanism according to the present invention.

1. A manually actuatable delivery device for the delivery of a volume of liquid comprising:
a housing which includes an outlet through which liquid, in use, is delivered;
a liquid delivery unit which is located within the housing; and
an actuating means moveable from a first position to a second position when acted upon by a user characterised in that
the liquid delivery unit is held by a locking mechanism in a non-actuatable mode and the actuating means cooperates with an interfering member as it moves from the first position to the second position such that the interfering member eventually releases the liquid delivery unit from the locking mechanism to enable delivery of the liquid.

2. A manually actuatable delivery device as claimed in claim 1, wherein the interfering member is moveable against the biasing action of a biasing means.

3. A manually actuatable delivery device as claimed in claim 2, wherein the actuating means lifts the interfering member into contact with the locking mechanism.

4. A manually actuatable delivery device as claimed in claim 3, wherein the actuating means cooperates with the interfering member by way of a coupling member.

5. A manually actuatable delivery device as claimed in claim 4, wherein the coupling member lifts the interfering member into contact with the locking mechanism.

6. A manually actuatable delivery device as claimed in claim 5, wherein the interfering member is a tubular member which is slidable with respect to the liquid delivery unit.

7. A manually actuatable delivery device as claimed in claim 5 or claim 6, wherein the locking mechanism is an expandable collar.

8. A manually actuatable delivery device as claimed in claim 7, as dependent on claim 6, wherein the tubular member moves into contact with the expandable collar as the actuating means is moved into the second position, such that the collar widens in diameter to allow the liquid delivery unit to pass through it and deliver a volume of liquid.

9. A manually actuatable delivery device as claimed in claim 8, wherein the delivery device further comprises a carrier unit for the liquid delivery unit, the carrier unit and liquid delivery unit being slidable as a single unit within the housing.

10. A manually actuatable delivery device as claimed in claim 9, wherein the tubular member slides on the carrier unit.

11. A manually actuatable delivery device as claimed in claim 10, wherein the biasing means is a spring located between the carrier unit and the tubular member which is compressed as the tubular member is lifted by the coupling member.

12. A manually actuatable delivery device as claimed in any preceding claim, wherein the liquid delivery unit comprises a container for the liquid and a pump with a tubular nozzle, the tubular nozzle being slidable into the container to deliver a volume of liquid as a result of cooperation with a tubular feed within the housing which leads to the outlet.

13. A manually actuatable delivery device as claimed in any preceding claim, wherein the user actuates the actuating means by applying a force substantially orthogonal to the axis of delivery of the liquid.

14. A manually actuatable delivery device as claimed in any preceding claim, wherein the actuating means comprises a cover member which is moveably disposed relative to the housing between a first position in which the cover member at least partly covers the outlet and a second position in which the cover member acts as a lever to which the user applies force to actuate the delivery device.

15. A manually actuatable delivery device substantially as herein described with reference to the accompanying drawings.
